(19) United States
(12) Patent Application Publication
(10) Pub. No.: US 2022/0014031 A1
(43) Pub. Date: Jan. 13, 2022

(54) COMBINED HEAT AND POWER SOURCE HAVING OUTER LAYER COMPRISING CORK

(71) Applicant: Datafly Commerce Inc., Draper, UT (US)

(72) Inventors: Scott Richard Thomas, Draper, UT (US); Gerardo David Ayala, Cedar Hills, UT (US); Joel McDavitt, Salt Lake City, UT (US)

(73) Assignee: Datafly Commerce Inc., Draper, UT (US)

(21) Appl. No.: 17/482,313

(22) Filed: Sep. 22, 2021

Related U.S. Application Data
(60) Provisional application No. 63/081,908, filed on Sep. 22, 2020.

(51) Int. Cl. H02J 7/00; G06F 1/28

(52) U.S. Cl. CPC H02J 7/0042; G06F 1/28

(57) ABSTRACT

Portable electronic devices having an outer layer comprising cork. Such portable electronic devices are portable, compact, and relatively lightweight. The outer layer comprising cork provides improvements in functional performance and ergonomic benefits as compared to hand warmers having polymer or metallic outer layers. The portable combined hand warmer and power bank with an outer layer comprising cork exhibits improvements in heat retention, heat distribution, and limited heat transfer to the initial touch. The outer layer comprising cork is comfortable and relatively soft and grippy as compared to the plastic or metallic outer layers of conventional hand warmers. The portable electronic device having the unique outer layer comprising cork also repels and wicks moisture as compared to other hand warmers having plastic and/or metallic outer layers. The outer layer comprising cork can also be relatively anti-microbial and germ resistant.

### CROSS-REFERENCE TO RELATED APPLICATIONS

This application claims priority to and the benefit of U.S. Provisional Application No. 63/081,908, filed Sep. 22, 2020, the contents of which are incorporated herein by reference in its entirety and for all purposes.

### BACKGROUND OF THE INVENTION

The hand and foot warmer was first patented by Jonathan T. Ellis of New Jersey in 1891 as U.S. Pat. No. 444,395. The object of Ellis' invention was to provide a more efficient and convenient warming device for the pocket, or one that is sufficiently small to be easily portable and applicable to the face or other portion of the human body requiring warmth, or for a special application of heat for the purpose of reducing or alleviating pain or for other remedial purposes. The outer casings of Ellis' warmer were disclosed as preferably made of sheet metal in a concavo-convex form. When the hinged casings were held together by a locking or catching device they were disclosed as having a close resemblance to an ordinary watch case. The casings were perforated to allow an inflow of pure air and an outflow of gas.

More recent hand warmers have used air activated iron, lighter fuel, charcoal, and battery-operated hand warmers that use electrically resistive heating elements. To this day, conventional hand warmers implement traditional materials, such as metal casings and polymers, in their handwarmer designs to transfer heat to the hands and other portions of the body or clothing of the intended user. Thus, there remains a need for an improved hand warmer that implements unique materials having improved heat transfer attributes, is highly compact, portable, and a technologically high performing product.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

The present invention is directed to a portable electronic device. The portable electronic device can include a heat source configured to provide heat to an outer surface of the portable electronic device. The portable electronic device can include an electric power source, the electric power source configured to provide power to a first electronic interface of the portable electronic device. An outer layer of the portable electronic device comprises cork.

The outer layer comprising cork can further comprise glue. The glue binding the cork to a woven material. The woven material can include a Tetron Cotton woven fabric.

The first interface of the electric power source can provide an about 5 volts power source. The portable electronic device can further comprising a second interface, the second interface configured to connect to an external power source for recharging the electric power source of the portable electronic device. The first interface can be configured to provide recharging power to a computing device. The second interface can be configured to provide power to the power source of the portable electronic device and the first interface configured to provide power from the power source of the portable electronic device. The first interface can be different in interfacing shape than the second interface.

The outer layer of the portable electronic device can extend around a periphery of the portable electronic device. The outer layer can be adjacent to a metallic casing, the metallic casing can be aluminum and can transfer heat from resistive elements to the outer layer and to the hand of a person carrying the portable electronic device, for example.

The heat source can include two resistive elements disposed on opposing sides of a housing of the portable electronic device.

The portable electronic device can be substantially rectangular in shape with rounded corners and ends.

The portable electronic device can include a color changing optical heat setting indicator configured to indicate a heat level setting by emanating light of different color wavelengths.

The heat source can provide outer surface temperatures between about 90 degrees Fahrenheit and about 140 degrees Fahrenheit.

The outer layer of the portable electronic device comprising cork can maintain heat when the heat source is turned off. The heat maintenance efficiency of the outer layer comprising cork can be a 1-10 percent improvement in heat maintenance efficiency.

The portable electronic device being sized and configured to be held in a palm of a human hand. For example, the portable electronic device can be about 100 millimeters in length, about 40 millimeters in width, and about 15 millimeters in thickness. The corners and edges of the portable electronic device can have a radius of about 5 millimeters.

The portable electronic device can further include a single input button, the single input button providing input to a controller of the portable electronic device, the controller controlling a heat source level of the heat source of the portable electronic device.

A system for recharging a computing device or other electronic device is disclosed. In such systems, the portable electronic device can be used to provide power through the first interface to the computing device to recharge the computing device. The computing device can comprise a smartphone, tablet, or smart watch.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a portable electronic device from a front-left perspective view;

FIG. 2 illustrates a system of recharging a smart telephone using the portable electronic device and a USB cable;

FIG. 3 illustrates a single-button control configuration for controlling the functionality of the portable electronic device;

FIG. 4 illustrates a first power bank interface for recharging another electronic device and a second interface for recharging the portable electronic device as well as a dust cover for covering the first and second interfaces;

FIG. 5 illustrates the top and bottom of the portable electronic device;

FIG. 6 is a top exploded view of the components of the portable electronic device;

FIG. 7 is a cutout exploded view of the components of the portable electronic device;

FIG. 8A is a is a bottom exploded view of the components of the portable electronic device;

FIG. 8B illustrates an assembled view of the portable electronic device illustrating the location of resistive heating elements underneath a top layer comprising cork;

FIGS. 9A and 9B are flow diagrams illustrating control functionality of the portable electronic device; and

FIGS. 10A and 10B illustrate test results showing benefits in heat retention efficiency due to the outer layer comprising cork.

### DETAILED DESCRIPTION OF THE PREFERRED EMBODIMENTS

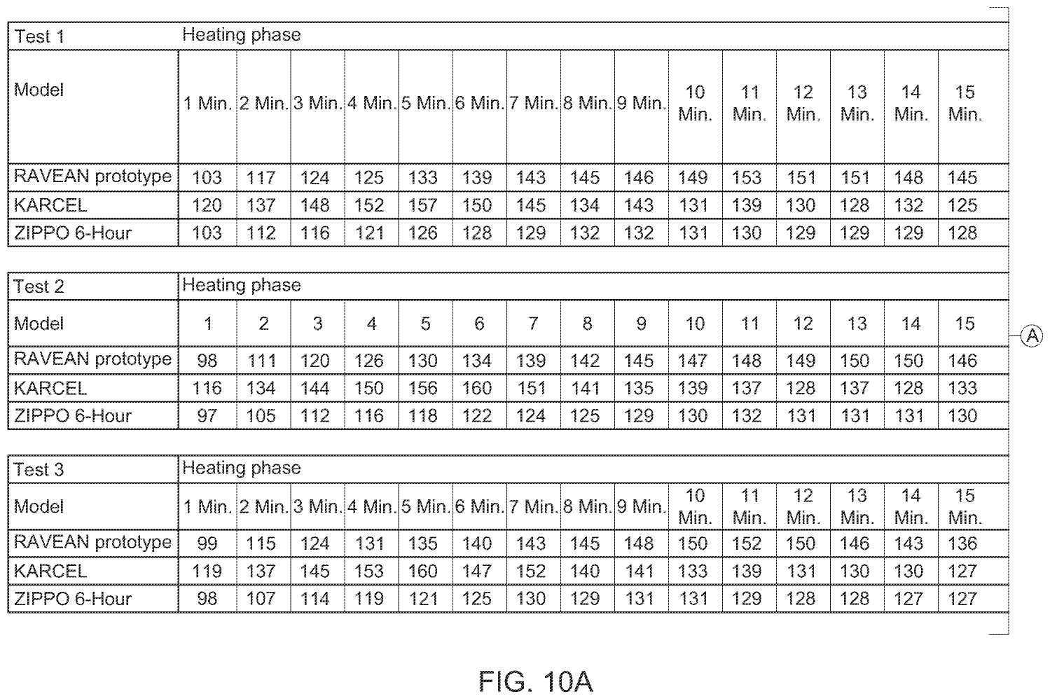

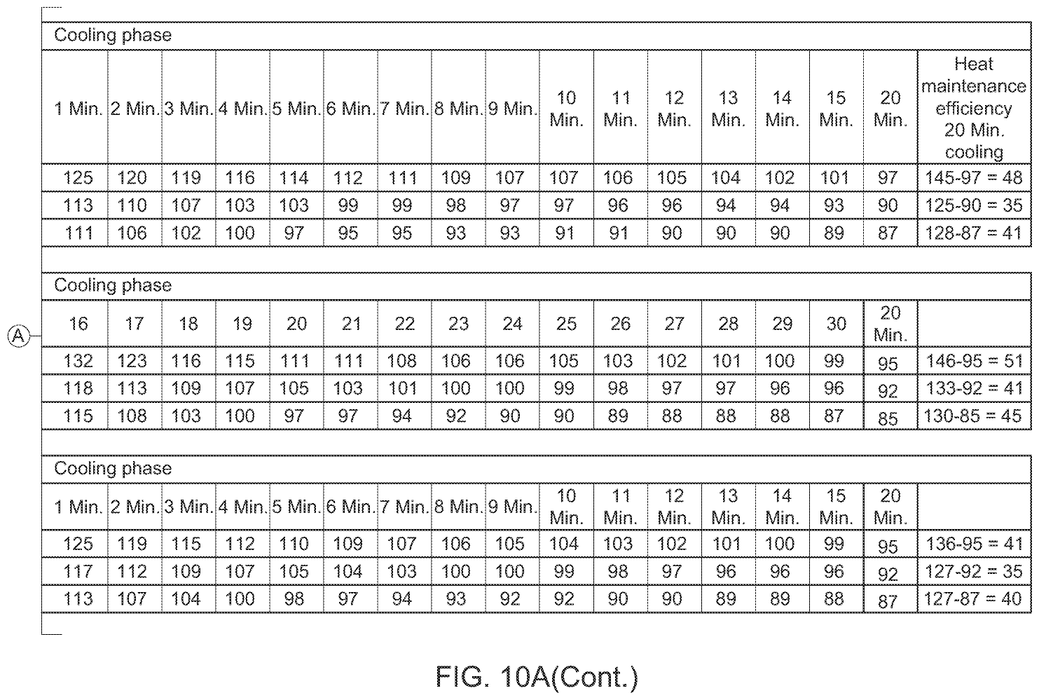

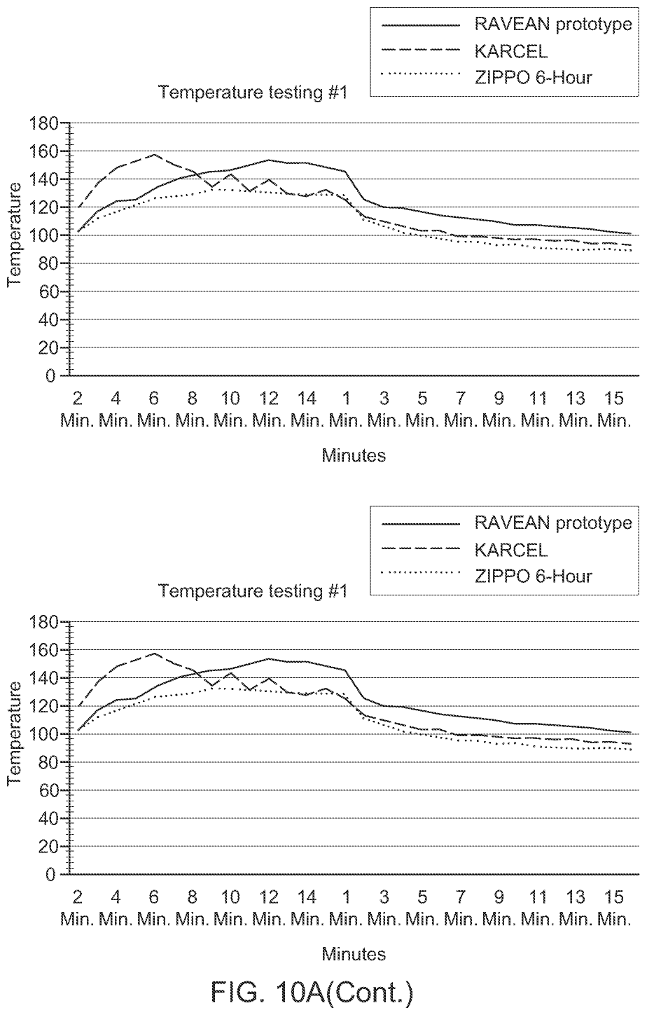

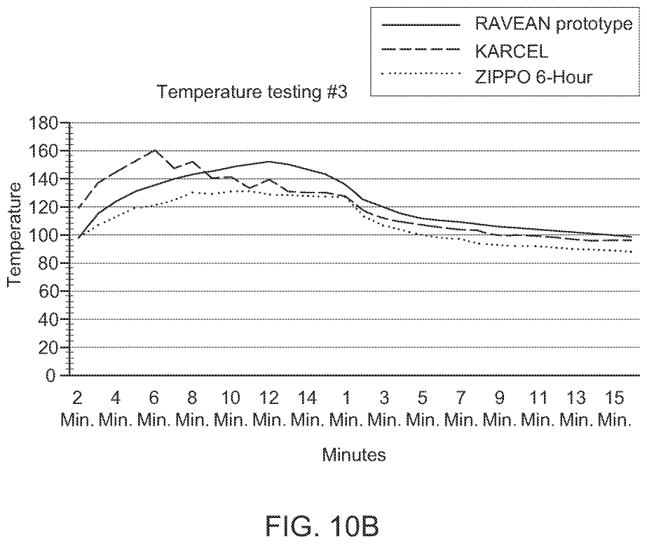

Embodiments of the invention disclosed herein relate to portable electronic devices with outer layer comprising cork. As discovered by the inventors of this patent application, in addition to a unique stylish appearance, the outer layer comprising cork provides unmatched functional performance and ergonomic benefits as compared to conventional hand warmers. This improvement in heat retention and limited heat transfer to the initial touch has been proven by certified heat retention labs results conducted by the inventors, discussed herein, and shown in FIGS. 10A and 10B. The performance and ergonomic improvements of the portable electronic device with the outer layer comprising cork has also been made clear from a multitude of positive user impressions and feedback.

For example, the portable electronic device having the outer layer comprising cork is also comfortable and grippy as compared to the plastic or metallic outer layers of conventional hand warmers. The portable electronic device having the unique outer layer comprising cork also repels and wicks moisture as compared to the conventional hand warmer's plastic and/or metallic outer layers, for example. The outer layer comprising cork of the portable electronic device can also promote heat retention and heat distribution, for example. And, the outer layer comprising cork of the portable electronic device described and disclosed herein can also be anti-microbial and germ resistant as compared to traditional hand warmers having metal or polymer outer layers, for example.

According to some embodiments, a portable electronic device having an outer layer comprising cork can be portable, compact, and relatively lightweight. For example, according to some embodiments, the portable electronic device having the outer layer comprising cork can weight about 5 ounces, for example, and be smaller in an outer peripheral dimension as compared to an average smart phone. Thus, the portable electronic device having the outer layer comprising cork can be easily carried in a pocket of pants, shorts, or jacket, for example.

The portable electronic device having the outer layer comprising cork can be substantially weather resistant and durable. The portable electronic device having the outer layer comprising cork can have an IPX4 water resistant rating and have an exterior treatment for retaining the exterior appearance of the outer layer comprising cork for several years. Moreover, the portable electronic device can have aluminum end caps in contrast in appearance, ergonomic comfort, and performance to the outer layer comprising cork disposed adjacent thereto. The function of the aluminum end caps of the portable electronic device provides synergistic functional improvements and user interfaces as compared to conventional plastic and/or metallic portable electronic devices.

The portable electronic device with outer layer comprising cork can include a five-volt USB-A charting port. The portable electronic device with the outer layer comprising cork can provide a two-amp output, for example to charge a mobile electronic device, such as a smart watch, smartphone, GOPRO, wireless headphones, tablet, laptop accessories, lighting device, portable speakers, etc. more than one and a half times.

The portable electronic device being sized and configured to be held in a palm of a human hand. For example, the portable electronic device can be about 100 millimeters in length, about 40 millimeters in width, and about 15 millimeters in thickness. The corners and edges of the portable electronic device can have a radius of about 5 millimeters.

The portable electronic device having the outer layer comprising cork can have three heat settings such as a low power setting (such as about 100° F.), a medium power setting (such as about 115° F.), and a high-power setting (such as 130° F.). The portable electronic device having the outer layer comprising cork can be powered by two 1860 lithium-ion batteries, for example. And the heat generated by the portable electronic device having the outer layer comprising cork can be generated via resistance elements with the use of a metal conductor/alloy. The portable electronic device with outer layer comprising cork can function as a power bank with a USB-A port for interfacing with other devices. The internal elements of the portable electronic device having the outer layer comprising cork can be surrounded by a plastic body. Then, heating elements of the portable electronic device having the outer layer comprising cork can be located on the plastic body of the portable electronic device. An aluminum cover of the portable electronic device can be used as a heating plate to help distribute heat evenly and can be located above and adjacent to the heating elements. The cork outer layer is wrapped around the aluminum cover helps to retain heat and improves (i.e. reduces) heat transfer to a user's hand upon initial contact.

The inventors of this patent application have also tested the heat transfer with thermal imaging against some of the most popular rechargeable hand warmer products currently sold finding marked improvements. The portable electronic device having the cork outer layer heated quicker, reached higher temperatures, distributed heat more evenly and retained heat longer as shown in FIGS. 10A and 10B and discussed in further detail hereinafter. The portable electronic device with the outer layer comprising cork of the present invention can also be referred to herein and in the figures as the RAVEAN portable electronic device.

Some embodiments of the portable electronic devices disclosed herein can include a simple single button functionality that adjusts the temperature and amount of heat thereby for user preference. Varying by conditions, the portable electronic device can produce heat for over eight hours on a low setting, over four and a half hours on a medium setting, and over three hours on its highest heat setting. Colored heat setting indicator lights can visually indicate the current heat setting. A set of adjacent light emitting diodes can indicate the portable electronic device's battery level. The portable electronic device can also provide 5200 mAh powered by two 18650 lithium-ion rechargeable batteries.

High-quality and large capacity lithium batteries can ensure longer service life and standby time of the portable electronic device. The portable electronic device can also serve as an emergency standby portable power source. Thus, the portable electronic device can charge user's electronic devices anytime and anywhere, such as when fishing, hiking, camping, skiing and other outdoor sports, as well as for people with ailments, such as Raynaud's arthritis who need heat treatment for their hands.

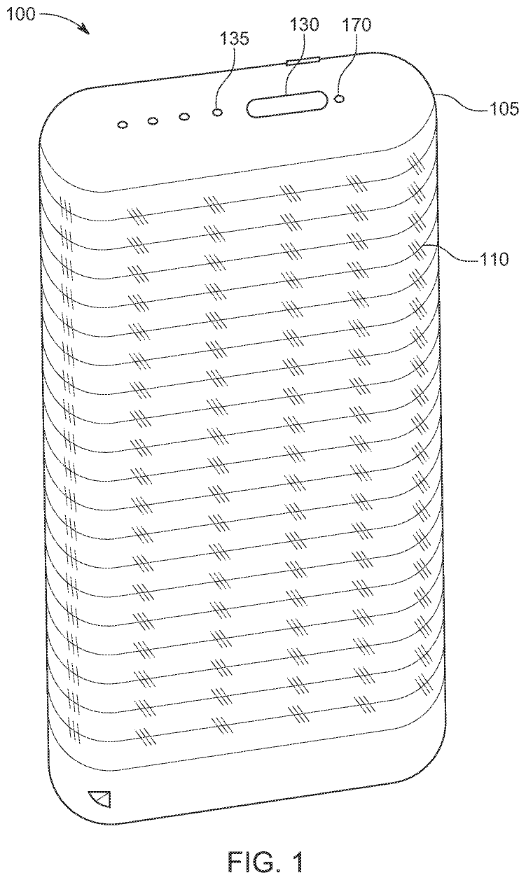

Referring to FIG. 1, a portable electronic device 100 with outer layer 110 comprising cork 100 is illustrated. The portable electronic device 100 with the outer layer comprising cork 110 further includes aluminum end caps 105.

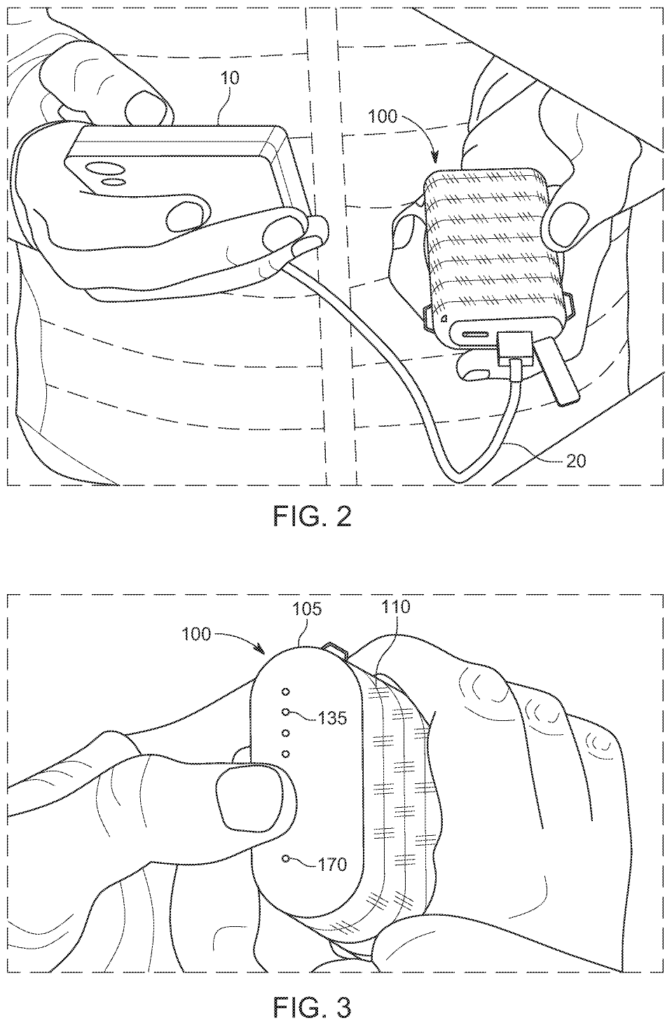

As shown in FIG. 2, the portable electronic device 100 with outer layer 110 comprising cork 100 can be used as a system to charge other electronic devices such as the handheld portable smartphone 10 shown in FIG. 2 via a USB cable 20. The cork-wrapped dual warming and charging device 100 can provide over 8 hours of warmth or one and a half mobile device charges according to some embodiments, for example.

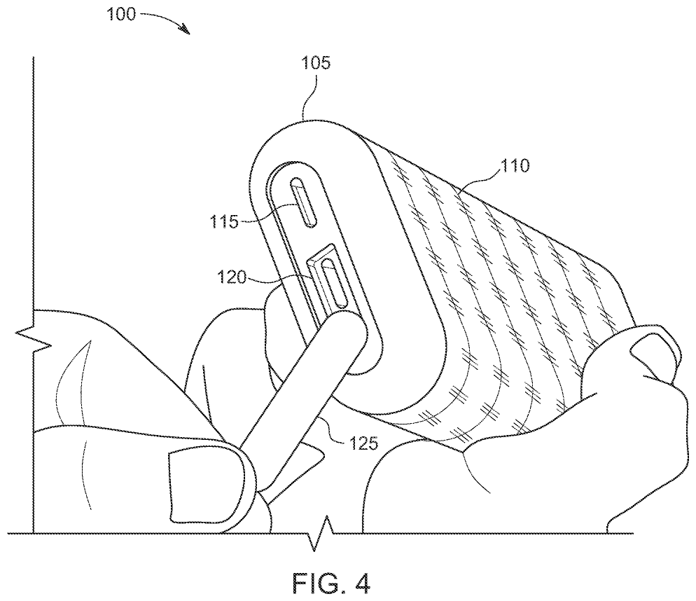

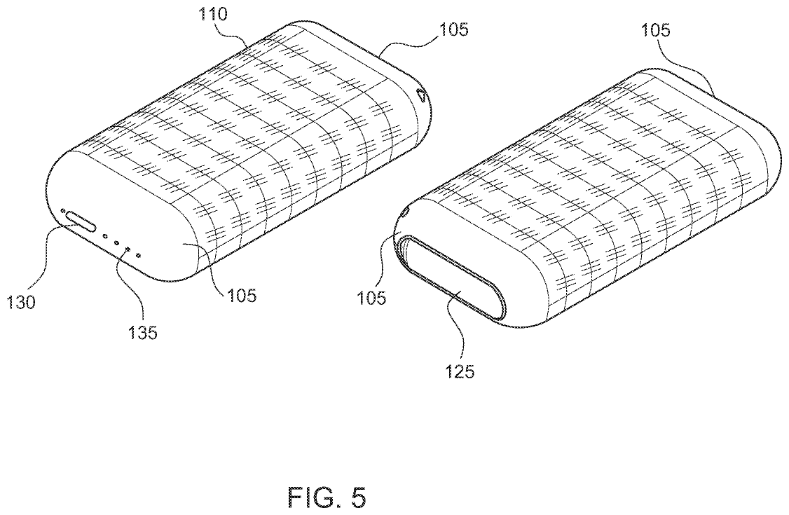

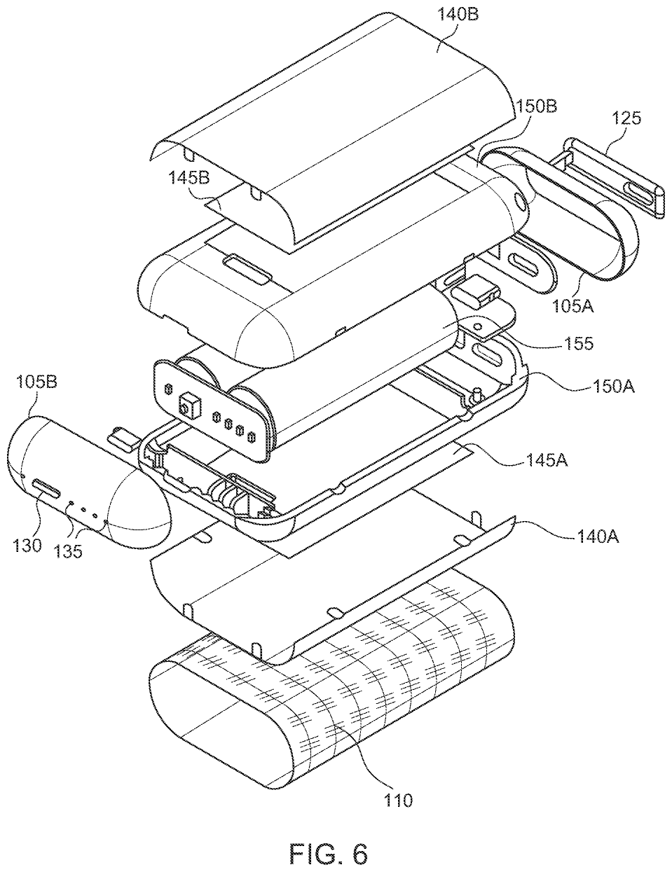

FIGS. 3-5, illustrates a portable electronic device 100 including a heat source and an electronic power source. As shown in FIGS. 6, 7, 8A, and 8B, the heat source includes two 1850 lithium-ion rechargeable batteries 155, a control circuit 160, and resistive heat elements 145A and 145B disposed on opposing plastic housing members 150A and 150B. The heat source is configured to provide heat through an aluminum housing 140A and 140B and to an outer surface layer 110 of the portable electronic device 100. The portable electronic device 100 further includes an electric power source including the two 1850 lithium-ion batteries 155 and USB interface 120 (see FIG. 4). The electric power source is configured to provide power to the USB interface 120 of the portable electronic device 100. The portable electronic device 100 further includes the outer layer 110, the outer layer 110 of the portable electronic device 100 comprising cork. The outer layer 110 can be a cork fabric layer comprising 40%-60% cork, for example. The outer layer 110 can be a cork material layer comprising 50% cork, 2% glue, and a woven 48% T/C cloth in some embodiments. T/C fabric refers to Tetron Cotton. It is a composition of cotton and polyester, but the polyester yarns in the fabric are generally more than 50 percent of the total combination with cotton in the T/C fabric.

The first USB interface 120 of the portable electronic device 100 can provide about 5 volts of power for recharging an electronic device (e.g., see FIG. 2). The portable electronic device can further include a second USB interface 115 (e.g., see FIG. 4) for charging the portable electronic device itself. The second interface 115 can be configured to connect to an external power source (not shown) for recharging the batteries 155 of the electric power source of the portable electronic device 100. The first interface can be configured to provide recharging power to a computing device such as a smart phone, smart watch, or tablet, for example (e.g. see FIG. 2). Thus, the second interface 115 is configured to provide power to recharge the batteries 155 of the power source, and the first interface 120 is configured to provide power from the portable electronic device 100 to another electronic device to recharge the other electronic device (e.g. see FIG. 2). Thus, the portable electronic device 100 can also be referred to as a dual power bank and hand warmer device.

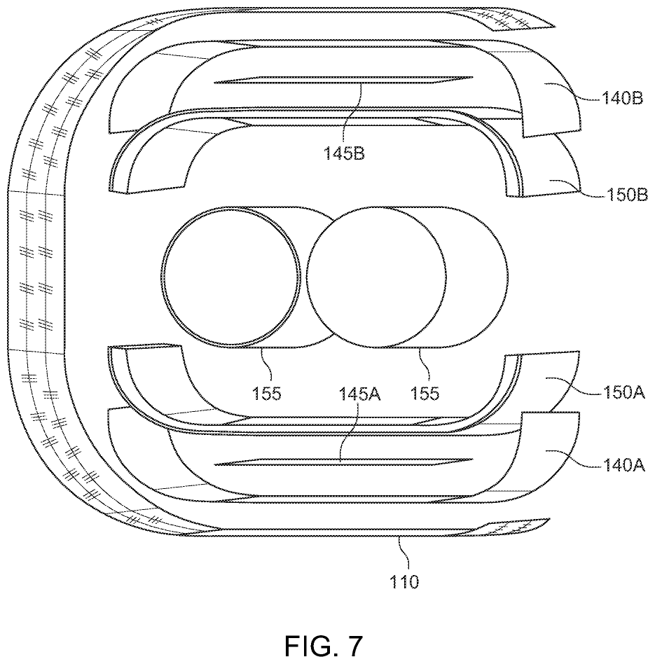

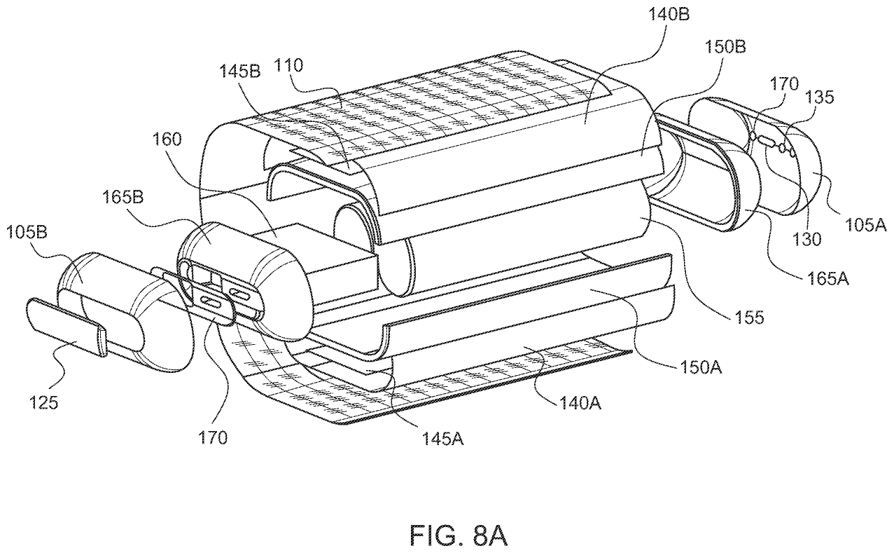

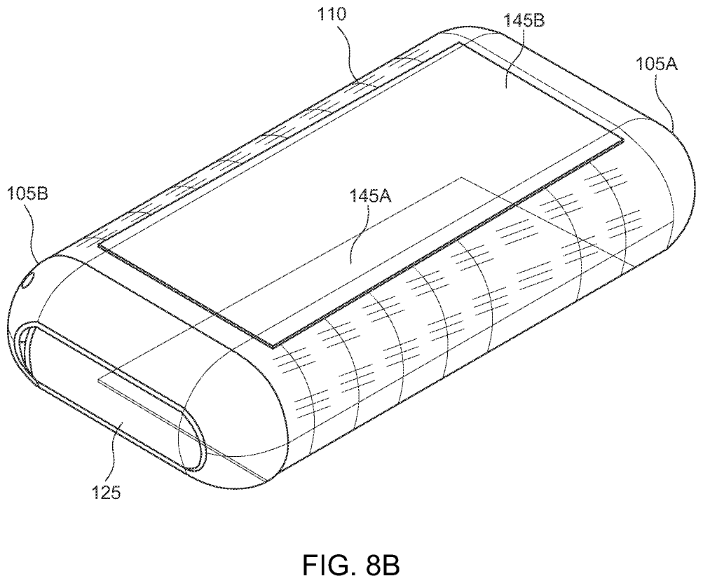

FIG. 7 illustrates a cut-away portion of the components of the portable electronic device 100 prior to assembly. FIGS. 8A and 8B show assembly of the components of the portable electronic device 100. FIG. 8B illustrates placement of the resistive heating elements 145A and 145B underneath the outer layer 110 comprising cork as further illustrated in FIGS. 7 and 8A.

The outer layer of the portable electronic device 100 including the outer layer 110 comprising cork can maintain heat when the heat source is turned off. The heat maintenance efficiency of the outer layer 110 comprising cork can be a 1-10 percent improvement in heat maintenance efficiency. The heat maintenance efficiency of the outer layer 110 comprising cork can be at least a two percent improvement in heat maintenance efficiency, for example.

The portable electronic device 100 can be sized and configured to be held in a palm of a human hand. For example, the portable electronic device can be between about 80 and 100 millimeters in length, about 30 and 50 millimeters in width, and about 10 to 20 millimeters in thickness. The corners and edges of the portable electronic device can have a radius of between about two and eight millimeters. For example, the portable electronic device can be about 100 millimeters in length, about 40 millimeters in width, and about 15 millimeters in thickness. The corners and edges of the portable electronic device can have a radius of about 5 millimeters, for example.

Referring to FIGS. 6, 7, 8A and 8B, the portable electronic device 100 further includes a printed circuit board controller 160, a silicone interlay 170, opposing plastic end caps 165A and 165B, the opposing aluminum end caps 105A and 105B, and dust cover 125. The layers of the body 150 encasing the batteries 155 and control circuit board 160 include an interior plastic shell 150A and 150B, heating elements 145A and 145B, aluminum heat conductive shell 140A and 140B, and the outer layer 110 comprising cork.

Referring to FIGS. 3, 5, 9, and 10, the portable electronic device 100 can further include a color changing optical heat setting indicator 170 configured to indicate a heat level setting by emanating light of different color wavelengths. For example, the heat source of the portable electronic device can provide surface temperatures at the outer layer between about 19 degrees Fahrenheit and about 140 degrees Fahrenheit. For example, a first low heat temperature setting can be about 100-105 degrees Fahrenheit, a second medium heat temperature setting can be about 115-120 degrees Fahrenheit, and a third high heat temperature setting can be about 130-135 degrees Fahrenheit. The optical heat setting indicator 170 can indicate a first low heat temperature setting by emanating a blue light, indicating a second medium heat temperature setting by emanating a green light, and indicating a third high heat temperature setting by emanating a red light, for example. Any different levels of heat temperature settings and different color of light emanating can be used according to the teaching disclosed herein.

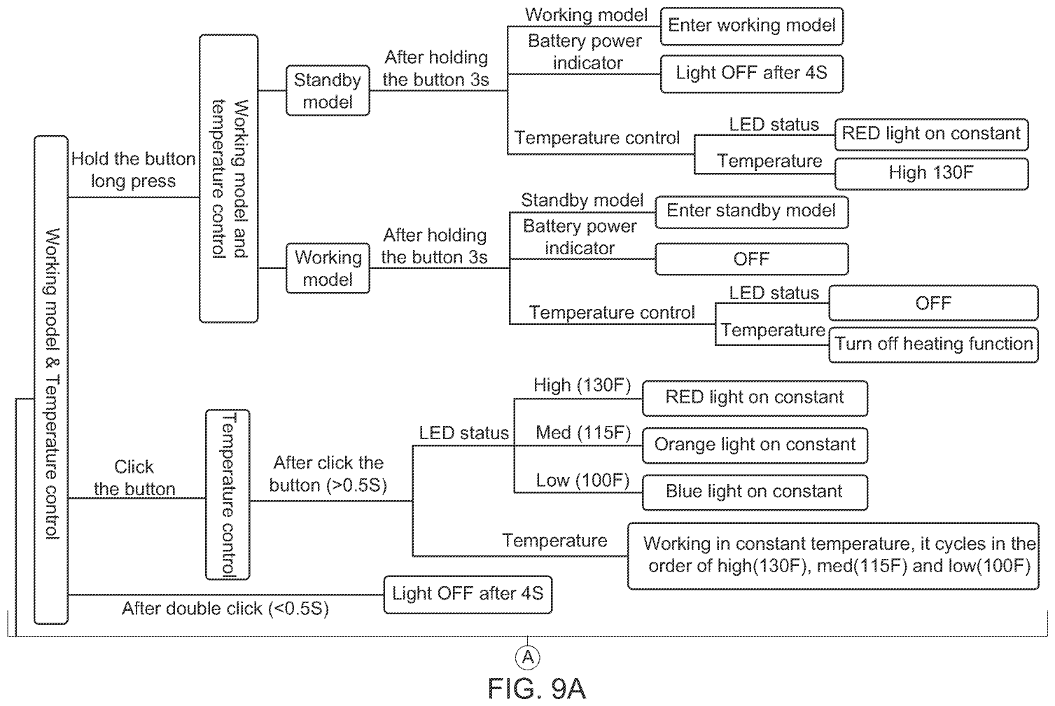

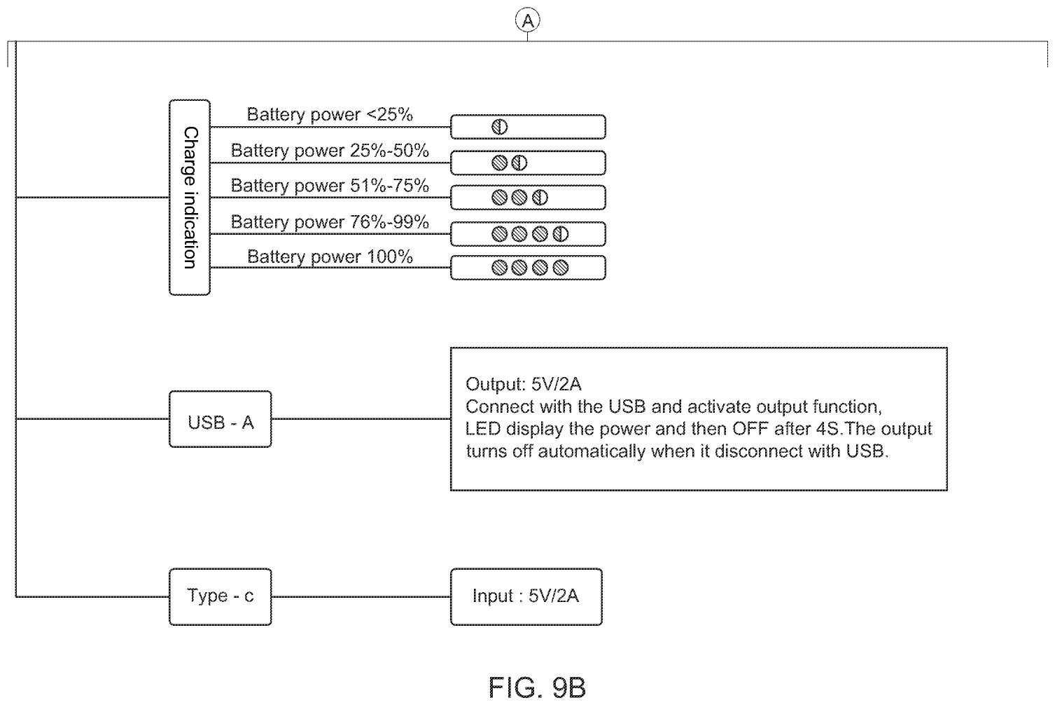

As shown in FIG. 3 and shown in the working flow chart for the MCU control flow diagrams illustrated in FIGS. 9 and 10, the portable electronic device 100 can have a single input button 130. The single input button 130 can provide input to the controller 160 of the portable electronic device 100. The controller 160 controlling the heat source level setting of the heat source of the portable electronic device 100.

The portable electronic device 100 can include a simple single button 130 functionality, in some embodiments, that can allow a user to select a preferred amount of heat generation by sequentially pressing the single button 130 to select different heat level settings. According to some embodiments, the portable electronic device 100 can produce a heat output run time of over eight hours of heat output on the lowest setting, four and a half hours of heat output on the medium heat output setting, and three and a half hours of heat output on the heat output setting.

According to some embodiments of the portable electronic device 100, the colored indicator light 170 can include a blue colored indicator light indicating a low heat level setting, a green colored indicator light indicating a medium heat level setting, and a red indicator light indicating a high heat level setting. Any other color scheme, light layout, or mechanism may be used for indicating a heat level setting. A series of light emitting diodes (LEDs) 135 of the portable electronic device can indicate the portable electronic device's 100 battery level.

The portable electronic device 100 can include a control device, such as a microcontroller unit (MCU) 160 for controlling and providing the functionality described herein. For example, referring to FIGS. 9 and 10, the working flow chart for the portable electronic device's 100 MCU controller 160 is illustrated. The MCU controller 160 is a small computer on a single metal-oxide-semiconductor (MOS) integrated circuit (IC) chip.

FIGS. 10A and 10B shows the results of the heat maintenance efficiency test previously discussed. It is to be noted that in the graphs shown in FIG. 10A, the goal was to reach the temperature settings desired temperatures, which were the baseline. All three models shown were supposed to reach within 125-130 degrees Fahrenheit. The outer layer that comprises cork 110 enabled maintenance of the specific temperature and heat retention. A twenty-minute check was added after cool down, which in room temperature was the amount of time expected that these units would start to return to a baseline temperature in an turned-off state. As shown in FIGS. 10A and 10B, application of the outer layer 110 comprising cork retained the heat for the RAVEAN unit such that the elevated temperature thereof remained well after the other portable heat producing electronic devices in the market.

Another aspect is that, although the portable electronic device 100 disclosed herein may have the same surface temperature, the outer layer 110 comprising cork does not have the initial feeling of heat when picking up, or holding, the portable electronic device 100 disclosed herein as opposed to the other currently available portable heat generating portable electronic devices with non-cork outer surface materials. What the inventors of this patent application found is that the rate of transfer in heat from metal to skin is much quicker than with cork. Metal is a great conductor, which also causes it to lose heat much faster. Cork, on the other hand, is a poor conductor; but once heated up, cork reduces the amount of heat that immediately transfers to skin of the user. This slight delay in heat transfer enables a much better user experience. The portable hand warmers tested with metallic outer surfaces, even at the same temperature as the portable electronic device 100 with the outer layer 110 comprising cork disclosed herein, feel almost too hot to hold. Thus, in addition to the ergonomic benefit of feeling relatively soft as compared to metal and plastic, there is a slight delay in heat transfer from the outer layer 110 comprising cork to the hand of a user resulting in a much better user experience.

As shown by the flow charts of FIGS. 9A and 9B, to power on the portable electronic device 100 the button 130 is held for 3 seconds. The portable electronic device 100 will power on and auto set to the high temperature level setting. To change temperature settings, the button 130 is pressed once to adjust the heat level. There can be three heat settings to adjust the heat to the desired level. The light 170 indicates the selected heat level as previously discussed. To power off the portable electronic device 100 the button 130 is held for three seconds.

To check the battery level the button 130 is pressed twice and the battery level LEDs 135 indicate the battery level. For example, four LEDs equals 75%-100%, 3 LEDs equals 51%-75%, two LEDs equals 25%-50%, and 1 LED equals less than 25%.

It is understood that when an element is referred hereinabove as being “on” another element, it can be directly on the other element or intervening elements may be present there between. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” “third,” are used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Herein is presented a newborn anti-scratch and chew mitt. The disclosure is illustrated by example in the drawing figures, and throughout the written description. It should be understood that numerous variations are possible, while adhering to the inventive concept. Such variations are contemplated as being a part of the present disclosure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable electronic device, comprising:
a heat source configured to provide heat to an outer surface of the portable electronic device;
an electric power source, the electric power source configured to provide power to a first electronic interface of the portable electronic device; and
an outer layer of the portable electronic device, the outer layer of the portable electronic device comprising cork.

2. The portable electronic device according to claim 1, wherein the outer layer comprising cork further comprises glue.

3. The portable electronic device according to claim 2, the glue binding the cork to a woven material.

4. The portable electronic device according to claim 1, the first interface of the electric power source providing an about 5 volts power source.

5. The portable electronic device according to claim 1, further comprising a second interface, the second interface configured to connect to an external power source for recharging the electric power source of the portable electronic device.

6. The portable electronic device according to claim 5, the first interface configured to provide recharging power to a computing device.

7. The portable electronic device according to claim 5, the second interface configured to provide power to the power source of the portable electronic device and the first interface configured to provide power from the power source of the portable electronic device.

8. The portable electronic device according to claim 5, wherein the first interface is different in interfacing shape than the second interface.

9. The portable electronic device according to claim 1, the outer layer of the portable electronic device extending around a periphery of the portable electronic device.

10. The portable electronic device according to claim 1, the heat source comprising two resistive elements disposed on opposing sides of a housing of the portable electronic device.

11. The portable electronic device according to claim 1, further comprising metallic end caps disposed on opposing end of the portable electronic device and adjacent to the outer layer comprising cork.

12. The portable electronic device according to claim 1, the portable electronic device being substantially rectangular in shape with rounded corners and ends.

13. The portable electronic device according to claim 1, further comprising a color changing optical heat setting indicator configured to indicate a heat level setting by emanating light of different color wavelengths.

14. The portable electronic device according to claim 1, the heat source providing surface temperatures between about 90 degrees Fahrenheit and about 140 degrees Fahrenheit.

15. The portable electronic device according to claim 1, the outer layer of the portable electronic device comprising cork maintaining heat when the heat source is turned off.

16. The portable electronic device according to claim 1, the portable electronic device being sized and configured to be held in a palm of a human hand.

17. The portable electronic device according to claim 1, further comprising a single input button, the single input button providing input to a controller of the portable electronic device, the controller controlling a heat source level of the heat source of the portable electronic device.

18. The portable electronic device according to claim 1, wherein the outer layer comprising cork comprises cork glued to a woven base material.

19. A system for recharging a computing device, comprising:
the portable electronic device according to claim 1; and
the computing device, the portable electronic device configured to provide power through the first interface to the computing device to recharge the computing device.

20. The system for recharging the computing device according to claim 19, the computing device comprising a smartphone, tablet, or smart watch.
